(19) United States
(12) Patent Application Publication
(10) Pub. No.: US 2026/0278128 A1
(43) Pub. Date: Sep. 17, 2026

(54) EXTENSIBLE OBJECT MODELING USING OBJECT TYPE AS CONTEXT

(71) Applicant: Honeywell International Inc., Charlotte, NC (US)

(72) Inventors: Veeranagegowda Shivalingappa, Hiriyuru (IN); Sumanth Pachipulusu Lingesh, Bengaluru (IN)

(21) Appl. No.: 19/080,130

(22) Filed: Mar. 14, 2025

(51) Int. Cl. G06F 21/62; G06F 40/186

(52) U.S. Cl. CPC G06F 21/6209; G06F 40/186; G06F 2221/2141

(57) ABSTRACT

Devices, methods, and systems for extensible object modeling using object type as context are described herein. One method includes receiving, via an interface, a request by a client for object data in an object modeling platform, determining an object type corresponding to the request, authorizing and validating the request using authorization and validation functionalities nonspecific to any object type, selecting a particular business logic, of a plurality of business logics, based on the determined object type and sending, to the client, the requested object data according to the particular business logic responsive to authorizing and validating the request.

### TECHNICAL FIELD

The present disclosure relates generally to devices, methods, and systems for extensible object modeling using object type as context.

### BACKGROUND

A platform for extensible object modeling provides customers and integrators the ability to configure and manage master data and digital models for a system, such an HVAC system, a fire system, or a security system, for instance. Digital models can represent objects such as sites, spaces, and/or assets (e.g., equipment), for instance, of the system.

Template-driven modeling allows users to define different object templates that include their own sets of data. Generally, the data of a template is configurable and can include attributes, relationships, metrics, etc.

### BRIEF DESCRIPTION OF THE DRAWINGS

FIG. 1 illustrates a networked computing system environment for extensible object modeling using object type as context, in accordance with one or more embodiments.

FIG. 2 is a screenshot of an example interface including a plurality of object templates, in accordance with one or more embodiments.

FIG. 3 is a screenshot of an example interface including a plurality of object instances, in accordance with one or more embodiments.

FIG. 4A is a portion of a screenshot of an example interface for customizing an object template, in accordance with one or more embodiments.

FIG. 4B is another portion of the screenshot of the example interface illustrated in FIG. 4A.

FIG. 5 is a screenshot of an example interface for customizing an instance, in accordance with one or more embodiments.

FIG. 6 illustrates a plurality of subsystems used in extensible object modeling under previous approaches.

FIG. 7 illustrates a system for extensible object modeling using object type as context, in accordance with one or more embodiments.

FIG. 8 is a screenshot of an example interface for selecting an object type, in accordance with one or more embodiments.

FIG. 9 illustrates an example of a method for extensible object modeling using object type as context, in accordance with one or more embodiments.

FIG. 10 is an example of a computing device for extensible object modeling using object type as context, in accordance with one or more embodiments.

### DETAILED DESCRIPTION

Devices, methods, and systems for extensible object modeling using object type as context are described herein. One method includes receiving, via an interface, a request by a client for object data in an object modeling platform, determining an object type corresponding to the request, authorizing and validating the request using authorization and validation functionalities nonspecific to any object type, selecting a particular business logic, of a plurality of business logics, based on the determined object type and sending, to the client, the requested object data according to the particular business logic responsive to authorizing and validating the request.

As previously discussed, a platform for extensible object modeling provides customers and integrators the ability to configure and manage master data and digital models for a system, such as an HVAC system, a fire system, or a security system, for instance. Digital models can represent objects such as sites, spaces, and/or assets (e.g., equipment), for instance, of the system.

Template-driven modeling allows users to define different object templates that include their own sets of data. The set of data included in a template reflects the type of object it represents. The types of data relevant to a “boiler” template, for example, will differ from the types of data relevant to a “smoke detector” template. Generally, the data of a template is configurable and can include attributes, relationships, metrics, etc.

Using a template, specific instances (referred to herein as “object instances” or simply “instances”) can be created. A template corresponds to a type of object being modeled, and an instance corresponds to a specific object of that type. As an example, the instance “Boiler_1356a1,” representing a specific boiler at a specific location of a facility, can be created from the template “boiler.” Templates can be arranged in a hierarchical structure in that a given template may be a parent template and/or a child template. For example, an “asset” template may have child templates for “fan” and “pump,” the latter of which may have its own child templates for “centrifugal pump” and “piston pump.”

Extensibility is a feature that provides the capability to customize template data during runtime. Additionally, new custom templates can be created with different sets of data by extending existing templates. Because of their hierarchical nature, modifications made to a template can propagate down to the child templates and the individual instances below it.

The present disclosure improves template-driven object modeling platforms by routing client requests for object data to a single object modeling system that is associated with a plurality of object types, rather than to one of a plurality of individual subsystems that are each associated with a different respective object type. Using a single object modeling system can save resources by minimizing duplication. For instance, the single system can encompass validation and authorization functionalities for all object types, whereas previous approaches duplicate these functionalities within each subsystem.

An object modeling system (e.g., a single object modelling system) in accordance with the present disclosure can include business logic plugins that are each specific to different object types. A client request (e.g., a create, read, update, or delete (CRUD) operation) can include (e.g., carry with it) the context of the object type specified in the request. The business logic corresponding to the specified object type can be applied by the object modeling system, and the data can be read or modified accordingly. Object types can include, for example, space, asset, asset group, team, organization, work order, site, and component. Each of these object types (and others) can have their own sets of business logic as plugins.

As an example, a request by a client for object data in an object modeling platform can be received (e.g., by the object modeling system) via an interface. The request can be received, for instance, responsive to a user interaction with the interface associated with modifying an object instance or an object instance template. An object type corresponding to the request can be determined (e.g., based on the context of the request). The request can be authorized and validated using authorization and validation functionalities that are nonspecific to any (e.g., are generic to) object type. A particular business logic, of a plurality of business logics, can be selected based on the determined object type. The business logics can be, for instance, business logic plugins each associated with a different object type, and the selected business logic can be the business logic plugin associated with the determined object type. The requested object data can be provided (e.g., sent to the client) according to the particular business logic responsive to authorizing and validating the request.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

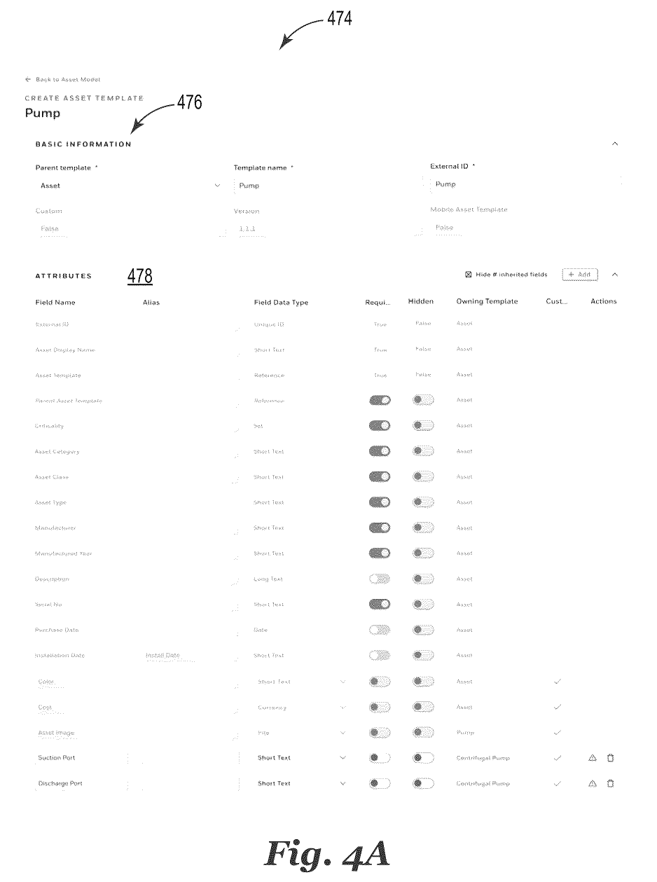

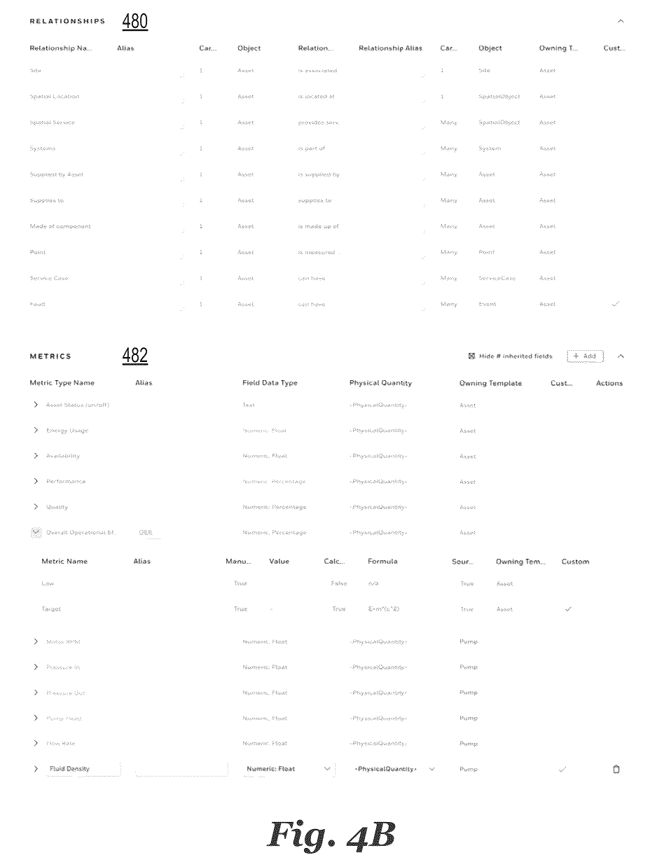

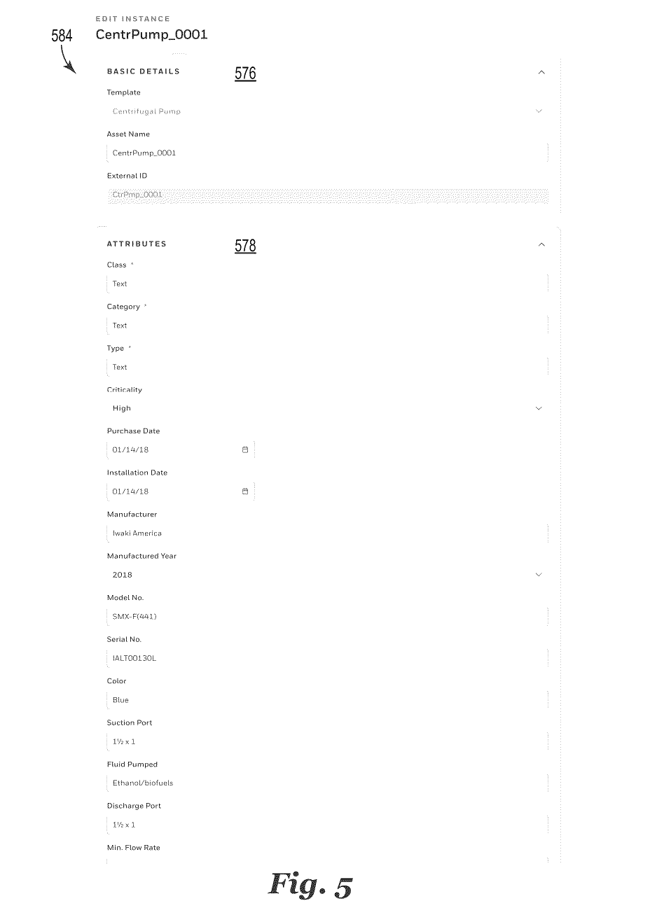

The figures herein follow a numbering convention in which the first digit or digits correspond to the drawing figure number and the remaining digits identify an element or component in the drawing. Similar elements or components between different figures may be identified by the use of similar digits. For example, 476 may reference element “76” in FIGS. 4A and 4B, and a similar element may be referenced as 576 in FIG. 5.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designators “a”, “b”, and “n”, as used herein, particularly with respect to reference numerals in the drawings, indicates that a number of the particular feature so designated can be included with a number of embodiments of the present disclosure.

An object modeling platform in accordance with the present disclosure is an extensible platform that is portable for deployment in any cloud or data center environment for providing an enterprise-wide, top to bottom view, displaying the status of processes, objects, people, and safety. The object modeling platform may include a number of layers including, for example, an extensible object model (EOM) that includes one or more knowledge graphs. The EOM may be a collection of application programming interfaces (APIs) that enables a seeded semantic object model to be extended. The extensible object model further enables a customer's knowledge graph to be built subject to the constraints expressed in the customer's semantic object model. A knowledge graph describes real world entities and their interrelations, organized in a graph. A knowledge graph defines possible classes and relations of entities in a schema, and enables the interrelating of potentially arbitrary entities and covers various topical domains. Knowledge graphs may include large networks of entities, their semantic types, properties, and relationships between entities. The entities may be physical entities or non-physical entities, such as data.

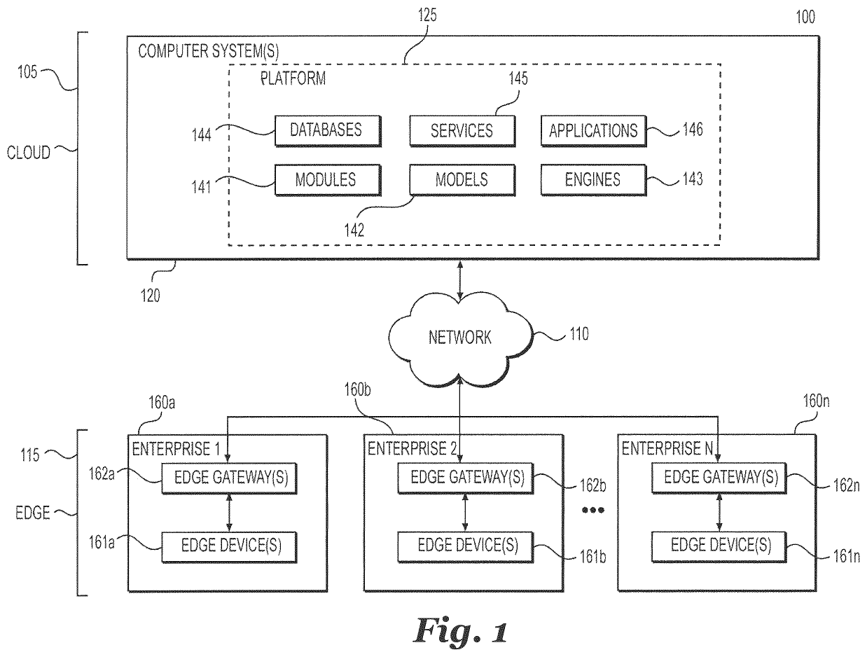

FIG. 1 illustrates a networked computing system environment 100 for extensible object modeling using object type as context, in accordance with one or more embodiments. As illustrated in FIG. 1, networked computing system environment 100 is organized into a plurality of layers including a cloud layer 105, a network layer 110, and an edge layer 115. As detailed further below, components of the edge 115 are in communication with components of the cloud 105 via network 110.

Network 110 may be any suitable network or combination of networks and may support any appropriate protocol suitable for communication of data to and from components of the cloud 105 and between various other components in the networked computing system environment 100 (e.g., components of the edge 115). Network 110 may include a public network (e.g., the Internet), a private network (e.g., a network within an organization), or a combination of public and/or private networks. Network 110 may be configured to provide communication between various components depicted in FIG. 1. Network 110 may comprise one or more networks that connect devices and/or components in the network layout to allow communication between the devices and/or components. For example, the network 110 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 may be implemented using cellular networks, satellite, licensed radio, or a combination of cellular, satellite, licensed radio, and/or unlicensed radio networks.

Components of the cloud 105 include one or more computer systems 120 that form an object modeling platform 125. Computer systems 120 may include any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, the processors and data storage devices may comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100.

Computer systems 120 further include one or more software components of the object modeling platform 125. For example, the software components of computer systems 120 may include one or more software modules to communicate with user devices and/or other computing devices through network 110. For example, the software components may include one or more modules 141, models 142, engines 143, databases 144, services 145, and/or applications 146, which may be stored in/by the computer systems 120 (e.g., stored on the memory). The one or more processors may be configured to utilize the one or more modules 141, models 142, engines 143, databases 144, services 145, and/or applications 146 when performing various methods described in this disclosure.

Accordingly, computer systems 120 may execute a cloud computing platform (e.g., object modeling platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 may be combined to form fewer modules, models, engines, databases, services, and/or applications. In some embodiments, some of the modules 141, models 142, engines 143, databases 144, services 145, and/or applications 146 may be separated into separate, more numerous modules, models, engines, databases, services, and/or applications. In some embodiments, some of the modules 141, models 142, engines 143, databases 144, services 145, and/or applications 146 may be removed while others may be added.

The computer systems 120 are configured to receive data from other components (e.g., components of the edge 115) of networked computing system environment 100 via network 110. Computer systems 120 are further configured to utilize the received data to produce a result. Information indicating the result may be transmitted to users via user computing devices over network 110. In some embodiments, the computer systems 120 may be referred to as a server system that provides one or more services including providing the information indicating the received data and/or the result(s) to the users. Computer systems 120 are part of an entity, which may include any type of company, organization, or institution that implements one or more services. In some examples, the entity may be a platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n may represent any type of entity, facility, vehicle, etc. such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or vehicle that includes any number of local devices.

The objects (e.g., edge devices) 161a-161n may represent any of a variety of different types of devices that may be found within the enterprises 160a-160n. Objects 161a-161n are any type of device configured to access network 110, or be accessed by other devices through network 110, such as via an edge gateway 162a-162n. Objects 161a-161n may be IoT devices in some instances, which may therefore include any type of network-connected (e.g., Internet-connected) device. The objects 161a-161n may be sites, spaces, and/or assets. Assets can include, for example, sensors, actuators, processors, computers, valves, pumps, fans, ducts, vehicle components, cameras, displays, doors, windows, security components, HVAC components, factory equipment, and/or any other devices that may be connected to the network 110 for collecting, sending, and/or receiving information. Each object 161a-161n can include, or otherwise be in communication with, one or more controllers for selectively controlling a respective object 161a-161n and/or for sending/receiving information between the objects 161a-161n and the cloud 105 via network 110.

The edge gateways 162a-162n include devices for facilitating communication between the objects 161a-161n and the cloud 105 via network 110. For example, the edge gateways 162a-162n include one or more communication interfaces for communicating with the objects 161a-161n and for communicating with the cloud 105 via network 110. The communication interfaces of the edge gateways 162a-162n may include one or more cellular radios, Bluetooth, WiFi, near-field communication radios, Ethernet, or other appropriate communication devices for transmitting and receiving information. Multiple communication interfaces may be included in each gateway 162a-162n for providing multiple forms of communication between the objects 161a-161n, the gateways 162a-162n, and the cloud 105 via network 110. For example, communication may be achieved with the objects 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

The edge gateways 162a-162n may also include a processor and memory for storing and executing program instructions to facilitate data processing. For example, the edge gateways 162a-162n can be configured to receive data from the objects 161a-161n and process the data prior to sending the data to the cloud 105. Accordingly, the edge gateways 162a-162n may include one or more software modules or components for providing data processing services and/or other services or methods of the present disclosure. In some cases, any of objects 161a-nand edge gateways 162a-n may have their functionality combined, omitted, or separated into any combination of devices. In other words, an object and its gateway need not necessarily be discrete devices.

The object modeling platform 125 of the present disclosure is a platform for enterprise performance management that uses real-time accurate models and visual analytics to deliver intelligent actionable recommendations for sustained peak performance of the enterprise 160a-160n. The object modeling platform 125 is an extensible platform that is portable for deployment in any cloud or data center environment for providing an enterprise-wide, top to bottom view, displaying the status of processes, nodes, people, and safety.

As used herein, “extensible” refers to the ability to extend a data model to include new properties/columns/fields, new classes/tables, and new relations. Thus, the object modeling platform 125 is extensible with regards to objects 161a-161n and the applications 146 that handle those objects 161a-161n. For example, when new objects 161a-161n are added to an enterprise 160a-160n system, the new objects 161a-161n will automatically appear in the object modeling platform 125 so that the corresponding applications 146 can understand and use the data from the new objects 161a-161n.

In some cases, templates are used to facilitate configuration of instances of objects 161a-161n in the model using common structures. A template defines the typical properties for the objects 161a-161n of a given enterprise 160a-160n for a certain type of object. For example, a template of a pump includes modeling the pump having inlet and outlet pressures, speed, flow, etc. The templates may also include hierarchical or derived types of objects 161a-161n to accommodate variations of a base type of object 161a-161n. For example, a reciprocating pump, a centrifugal pump, and a piston pump would each be a specialization of a base pump type and would each include additional properties in the template. As an additional example, an axial fan would be a specialization of a base fan type and would include additional properties of the template. Instances of the objects 161a-161n in the model are configured to match the actual, physical objects of the enterprise 160a-160n using the templates to define expected attributes of the object 161a-161n. Each attribute is configured either as a static value (e.g., capacity is 1000 BPH) or with a reference to a time series tag that provides the value.

In some embodiments, models and templates can be used to define calculations and analytics, and to define how the calculations and analytics relate to the objects 161a-161n. For example, a pump template can define pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. The actual calculation or analytic logic may be defined in the template or it may be referenced. Thus, the calculation model can be used to describe and control the execution of a variety of different process models. Calculation templates can be linked with the node templates such that when an instance is created, any associated calculation instances are also created with their input and output parameters linked to the appropriate attributes of the object.

As previously discussed, CRUD operations include requests to read and/or modify an entity in the object modeling platform. Also as previously discussed, “entity” herein refers to an object instance template and/or a specific object instance. Such modifications can range from creation to updates to deletion and can include customizations or modifications to minor aspects of the entity. The interface of the object modeling platform provides a plurality of configurable options that allow a user to customize the type, manner, timing, etc. of various aspects of templates and/or instances.

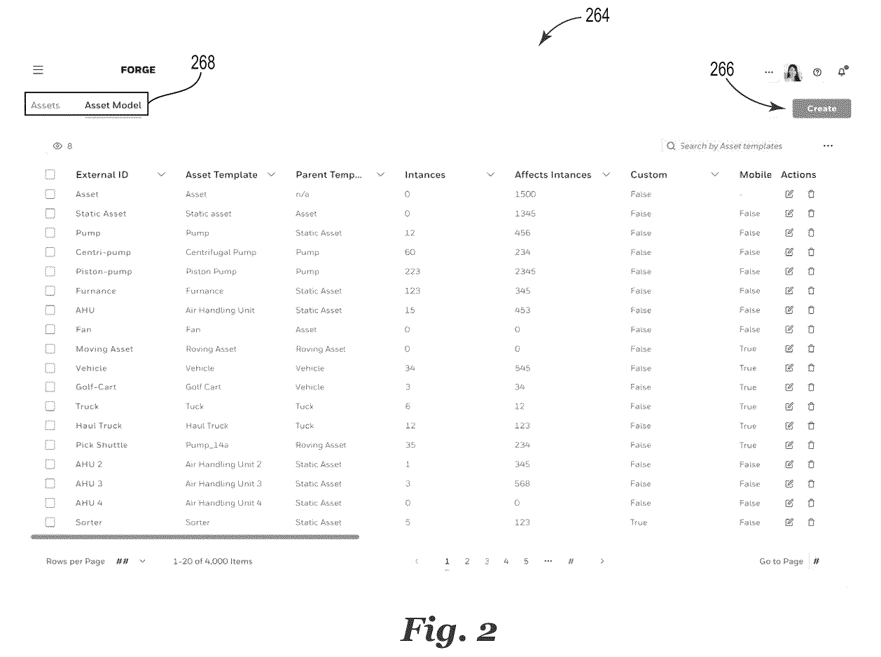

FIGS. 2-5 illustrate screenshots of example interfaces through which a user may traverse in modifying (e.g., creating, updating, or deleting) an object template. User interactions with these interfaces can cause CRUD operations, as described herein. Embodiments of the present disclosure are discussed in reference to these screenshots and in the context of these examples. However, it is again noted that embodiments herein are not so limited; operation(s) to customize a template serve merely to illustrate an example of operations that trigger changes to an object modeling platform's state.

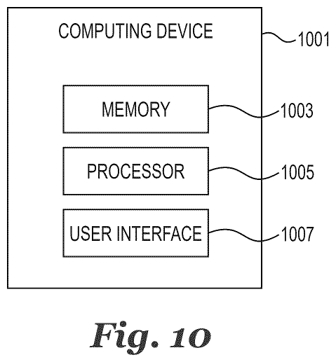

FIG. 2 is a screenshot of an example interface 264 including a plurality of object templates in accordance with one or more embodiments. Interface 264 can be provided (e.g., displayed) as a user interface of a computing device, such as, for instance, user interface 1007 of computing device 1001 further described in connection with FIG. 10.

As illustrated in FIG. 2, the interface 264 includes a list of object types under the heading “External ID.” It is noted that in the example illustrated in FIG. 2 and elsewhere herein, the specific example of “asset” may be used rather than the broader term “object.” It is to be understood that such usage is not to be taken in a limiting sense; as previously discussed, objects in accordance with the present disclosure include assets, sites and spaces. The names of the templates that correspond to the objects include, for example, “pump,” “centrifugal pump,” piston pump,” “furnace,” “truck,” “static asset,” etc. Additional information corresponding to the templates can be listed in columns, as illustrated in FIG. 2, for instance. This information can include the type of each template, the parent template of each template, the quantity of instances of each template, the quantity of instances affected by each template, and whether each template is a custom template, among other information.

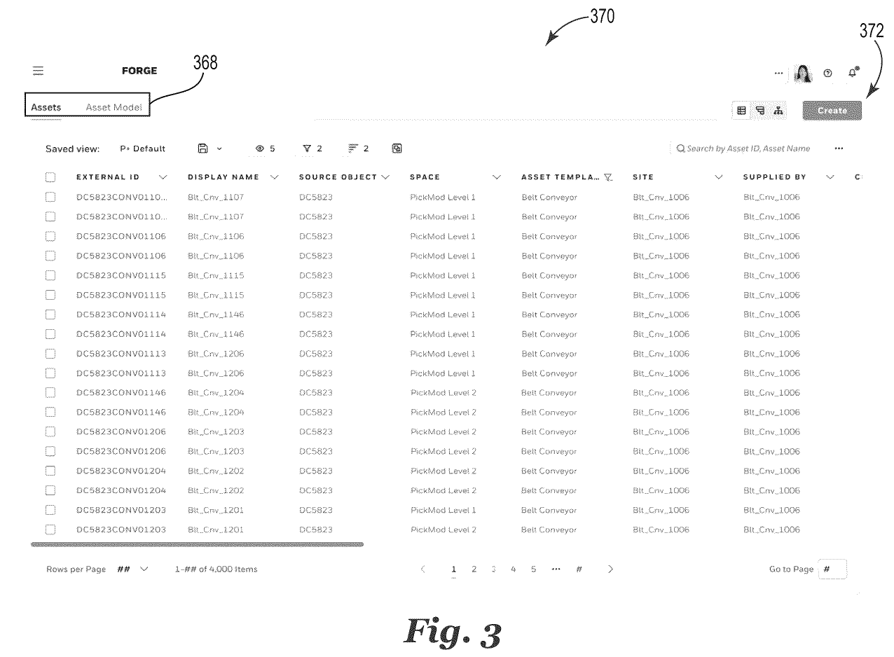

In some embodiments, selection of a template from the list illustrated in interface 264 causes the display of detailed information associated with the selected template. In some embodiments, selection of a template from the list illustrated in interface 264 allows the modification of the selected template. Selection of a display element (“create” button 266) can allow the creation of a new template using a different interface, described below in connection with FIG. 4. Selection of a toggling display element 268 can toggle the display to a plurality of object instances, which is described below in connection with FIG. 3.

FIG. 3 is a screenshot of an example interface including a plurality of object instances in accordance with one or more embodiments. Interface 370 can be provided (e.g., displayed) on a user interface of a computing device, such as, for instance, user interface 1007 of computing device 1001 further described in connection with FIG. 10.

As illustrated in FIG. 3, the interface 370 includes a list of instance names under the heading “External ID.” The names of the instances include, for example, “DC5823CONVO1106,” “DC5823CONVO1115,” etc. Additional information corresponding to the instances can be listed in columns in interface 370, as illustrated in FIG. 3, for instance. This information can include the display name of each instance, the name of the object that each instance represents (e.g., “SOURCE OBJECT”), the space in which each source object is located, the template used to create each instance, the site in which each source object is located, and the name(s) of object(s) that supply each object.

In some embodiments, selection of an instance from the list illustrated in interface 370 causes the display of detailed information associated with the selected instance. In some embodiments, selection of an instance from the list illustrated in interface 370 allows the modification of the selected instance. Selection of a display element (“create” button 372) can allow the creation of a new instance using a different interface, described below in connection with FIG. 5. Selection of the toggling display element 368 can toggle the display to the plurality of object instances, described above in connection with FIG. 2.

FIG. 4A is a portion of a screenshot of an example interface for customizing an object template, in accordance with one or more embodiments. FIG. 4B is another portion of the screenshot of the example interface illustrated in FIG. 4A. FIGS. 4A and 4B are cumulatively referred to herein as “FIG. 4.”

FIG. 4 is a screenshot of an example interface 474 for customizing an object template in accordance with one or more embodiments. Interface 474 can be provided (e.g., displayed) as a user interface of a computing device, such as, for instance, user interface 1007 of computing device 1001 further described in connection with FIG. 10.

Creating an object template can include utilizing the interface 474 to specify the particular attributes, relationships, and metrics that will be available to be populated with specific instance information when the template is later used to create an instance (described below in connection with FIG. 5). Accordingly, as illustrated in FIG. 4, the interface 474 can include a plurality of portions: a basic information portion 476, an attributes portion 478, a relationships portion 480, and a metrics portion 482, though embodiments herein are not limited to these example portions. It is noted that the term “portion,” as referred to herein, is a unit of an interface (e.g., a display). In some embodiments, a portion refers to a subset of an interface, such as a window, for instance. In some embodiments, a portion refers to a display element (e.g., a button) of an interface. In some embodiments, a portion refers to a page that constitutes an entirety of a display.

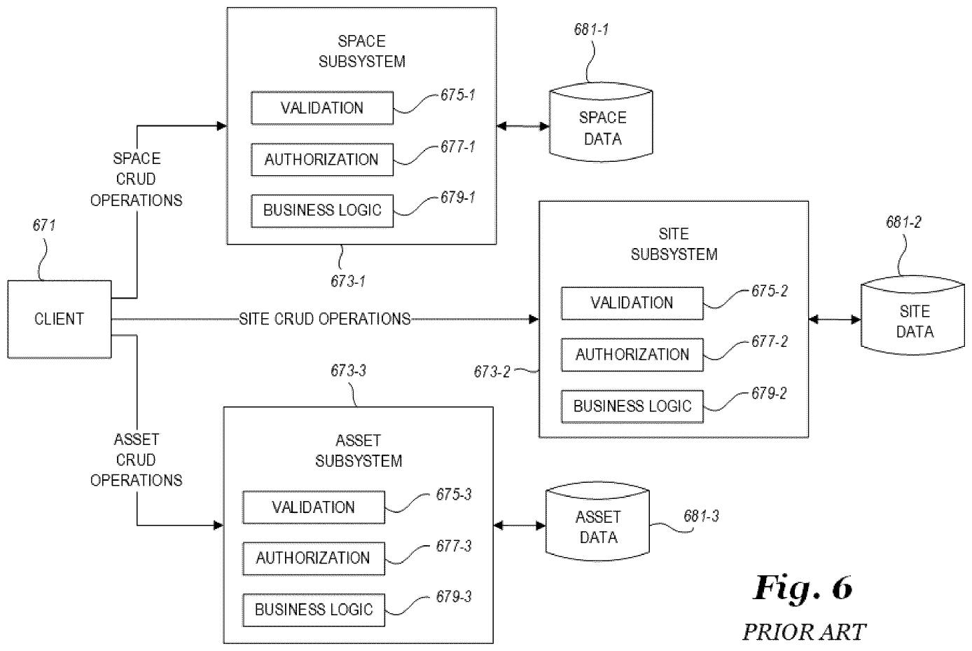

The basic information portion 476 can include the parent template of the template being created, the name of the template being created, the External ID of the template being created, an indication of whether the template being created is a custom template, a version of the template being created, etc. Selection of, and/or input into, any of the display elements of the basic information portion 476 can represent an operation (e.g., a CRUD operation) that is a request for object data as described herein (discussed in more detail below in connection with FIGS. 6 and/or 7).

The attributes portion 478 can include attributes of the template being created. The attributes portion 478 can allow the customization of which attributes (e.g., attributes of objects represented by instances created using the template) are to be included in the template. Attributes may include, for example, display name, category, class, type, manufacturer, manufactured year, description, serial number, purchase date, installation date, etc. As the template being created in the example illustrated in FIG. 4 is a “pump” template, the attributes portion 478 is shown as including a “suction port” field and a “discharge port” field. It is to be understood that these specific fields may be present in a pump template and absent in a golf cart template, for instance. Selection of, and/or input into, any of the display elements of the attributes portion 478 can represent an operation (e.g., a CRUD operation) that is a request for object data as described herein (discussed in more detail below in connection with FIGS. 6 and/or 7).

The relationships portion 480 can include relationship information corresponding to the template being created. The relationships portion 480 can allow the customization of what relationship information (e.g., relationship information corresponding to objects represented by instances created using the template) is to be included in the template. Relationship information may include, for example, site, spatial location, spatial service, etc. Selection of, and/or input into, any of the display elements of the relationships portion 480 can represent an operation (e.g., a CRUD operation) that is a request for object data as described herein (discussed in more detail below in connection with FIGS. 6 and/or 7).

The metrics portion 482 can include metrics of the template being created. The metrics portion 482 can allow the customization of which metrics (e.g., metrics corresponding to objects represented by instances created using the template) are to be associated with (e.g., included in) the template. Metrics may include, for example, status, energy usage, availability, performance, motor revolutions per minute (RPM), pressure in, pressure out, flow rate, etc. Selection of, and/or input into, any of the display elements of the metrics portion 482 can represent an operation (e.g., a CRUD operation) that is a request for object data as described herein (discussed in more detail below in connection with FIGS. 6 and/or 7).

A user can indicate the basic details, attributes, relationships, and metrics to be included in a template via the basic details portion 476, the attributes portion 478, the relationships portion 480, and the metrics portion 482, respectively, of the interface 474. As such, a user can customize a variety of aspects of templates using the interface portions described in connection with FIG. 4. Indications made by a user, of the basic details, attributes, relationships, and/or metrics to be included can represent operations (e.g., CRUD operations) that are requests for object data as described herein (discussed in more detail below in connection with FIGS. 6 and/or 7).

FIG. 5 is a screenshot of an example interface 584 for customizing an instance in accordance with one or more embodiments. Interface 584 can be provided (e.g., displayed) as a user interface of a computing device, such as, for instance, user interface 1007 of computing device 1001 further described in connection with FIG. 10.

The example illustrated in FIG. 5 depicts an instance being created from the template previously described in connection with FIG. 4. For example, the instance “CentrPump_001,” having been created using the template previously created using the interface 474 (previously described in connection with FIG. 4) can be customized using the interface 584. Accordingly, the basic details portion 576, the attributes portion 578, and the metrics portion (not shown in FIG. 5) include the basic details, the attributes, and the metrics that were previously customized using the interface 474. In some embodiments, the values of the various basic details, attributes, and/or metrics are user-entered. In some embodiments, the values the values of the various basic details, attributes, and/or metrics are received from a device. For example, the values can be received via an optical scan of a bar code associated with the object or from a computing device. In some embodiments, the values of the various basic details, attributes, and/or metrics are received from the object itself or from a sensing device associated with the object (e.g., in real time). Reception(s) of such values can represent operations (e.g., CRUD operations) that are requests for object data as described herein (discussed in more detail below in connection with FIGS. 6 and/or 7).

In some examples, the customization of templates can include the ability to create and modify notifications corresponding to object instances created using object templates. In some embodiments, the interface 474, previously described in connection with FIG. 4, can include a portion configured to receive a request to provide a notification regarding the object. Reception of such a request can represent operations (e.g., CRUD operations) that are requests for object data as described herein (discussed in more detail below in connection with FIGS. 6 and/or 7). In some embodiments, such a portion may be entitled “NOTIFICATIONS” and may be displayed in a manner analogous to the basic details portion 476, the attributes portion 478, the relationships portion 480, and the metrics portion 482. In some embodiments, a portion of the interface dedicated to notifications may be presented separately (e.g., responsive to the selection of a display element in the interface 474).

FIG. 6 illustrates a plurality of subsystems used in extensible object modeling under previous approaches. In previous approaches, a client 671 makes a request for object data. The request can be a request to create, read, update, and/or delete object data, which may be commonly referred to as a “CRUD operation.” As illustrated in the example shown in FIG. 6, in previous approaches the request is made to one of three subsystems (cumulatively referred to as subsystems 673) depending on the type of object to which the requested data corresponds. While the specific example of three subsystems 673 is illustrated in FIG. 6, it is to be understood that previous approaches can utilize a different plurality of subsystems depending on the number of different object types they employ (e.g., a different subsystem for each object type).

The subsystems 673 each comprise a respective set of services (e.g., a create service, a read service, an update service, a delete service, etc.) that correspond to respective object types. Each of the subsystems 673 are responsible for CRUD operations corresponding to a respective database. For instance, a space subsystem 673-1 is responsible for CRUD operations corresponding to a space database 681-1; a site subsystem 673-2 is responsible for CRUD operations corresponding to a site database 681-2; an asset subsystem 673-3 is responsible for CRUD operations corresponding to an asset database 681-3. As illustrated, previous approaches have a one-to-one relationship between subsystem and object type. Stated differently, the quantity of different object types supported by previous approaches to object modeling systems dictates the quantity of different subsystems it employs. These subsystems, however, are commonly duplicative and thus inefficient, particularly as the quantity of object types increases.

From the perspective of the client 671, a request for space data, for instance, can be made via a user interface to the space subsystem 673-1. The user interface may be an interface of an application dedicated to the object type “space.” Separate applications may be employed for “site,” “asset,” and/or other object types. This can be contrasted with embodiments of the present disclosure discussed below, which can be accessed from a single application, for instance.

A space validation functionality 675-1 that is specific to the space subsystem 673-1 can perform a validation on the request. For example, the validation functionality 675-1 can verify that the data associated with the request follows a specified pattern, falls within an acceptable range, is unique, and/or adheres to some other predefined criteria.

A space authorization functionality 677-1 that is specific to the space subsystem 673-1 can perform an authorization of the request. In some embodiments, a user will have logged in to the space application with credentials. Those credentials can be used to determine what portion of the space data in the space database 681-1 the user is allowed access based on the user's role. Stated differently, the user's access may be governed by the user's permissions. In addition, the space subsystem 673-1 may have its own business logic 679-1 that defines the operations of the space subsystem 673-1, such as how the space data of the space database 681-1 is created, modified, and/or communicated.

As with the space subsystem 673-1, the site subsystem 673-2 and the asset subsystem 673-3 can have their own respective elements. For instance, as shown in the example illustrated in FIG. 6, the site subsystem 673-2 may be accessed via an application dedicated to “site” and includes a site validation functionality 675-2, a site authorization functionality 677-2, and site business logic 679-2 for requests for data from a site database 681-2. Similarly, the asset subsystem 673-3 may be accessed via an application dedicated to “asset” and includes an asset validation functionality 675-3, an asset authorization functionality 677-3, and asset business logic 679-3 for requests for data from an asset database 681-3.

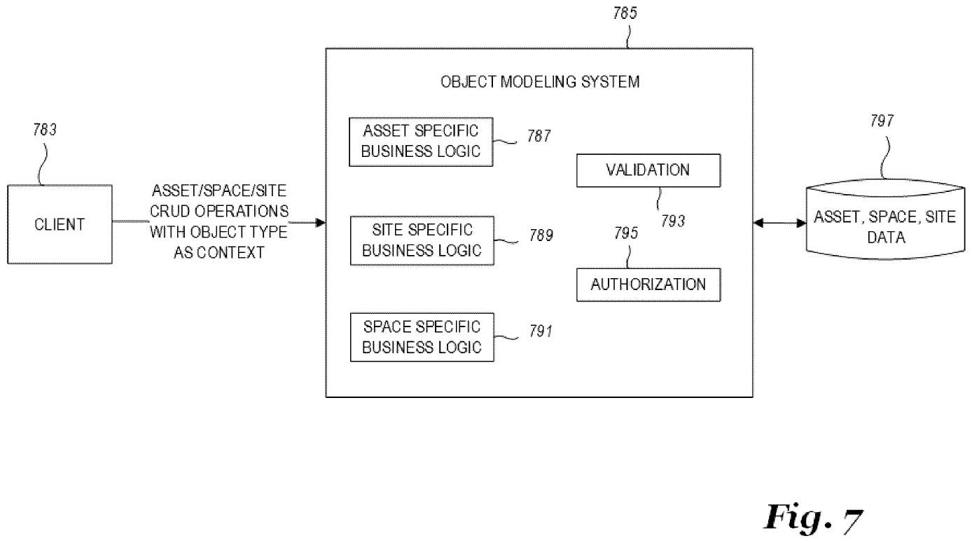

FIG. 7 illustrates a system for extensible object modeling using object type as context, in accordance with one or more embodiments. In contrast with the plurality of subsystems previously described in connection with FIG. 6, FIG. 7 illustrates a client 783 and a single object modeling system 785 in communication with a single shared database 797. Rather than multiple subsystems that each correspond to a respective object type with separate databases, the object modeling system 785 saves resources by reducing duplication. For instance, as shown in FIG. 7, a validation functionality 793 and an authorization functionality 795 are not reiterated for each object type. Rather, a single instance of the validation functionality 793 and the authorization functionality 795 that are nonspecific to any object type (e.g., can be used to validate and authorize any object type) can be executed by the object modeling system 785. Additionally, a single database 797 can be used instead of multiple databases associated with different object types.

The client 783 can be an object modeling platform, as previously described herein. In some embodiments, the object modeling platform includes an interface having a plurality of portions and can be accessed by a computing device, for instance, to modify an entity. The entity can be, for example, an object instance or an object instance template, as previously described herein. In some embodiments, the command is generated responsive to receiving a request to modify (e.g., create, read, update, and/or delete) the entity in the object modeling platform. The request to modify the entity can include a request to create the entity, a request to delete the entity, a request to customize an aspect of the entity, or a request to configure an object. Such a request can comprise a selection of a display element made using the interface and/or other inputs, such as alphanumeric inputs (e.g., typed data entries) made using the interface, as previously described herein.

In accordance with embodiments herein, business logic plugins specific to each object type can be executed by the object modeling system 785. For instance, as shown in the example illustrated in FIG. 7, the object modeling system 785 includes an asset specific business logic plugin 787, a site specific business logic plugin 789, and a space specific business logic plugin 791.

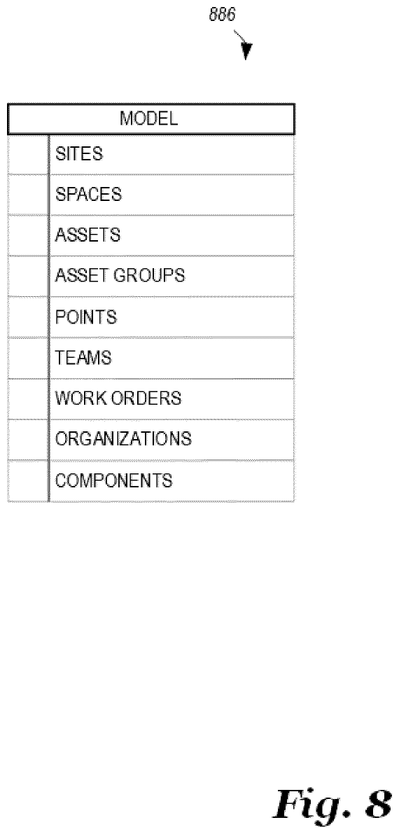

Turning briefly to FIG. 8, FIG. 8 is a screenshot of an example interface 886 for selecting an object type, in accordance with one or more embodiments. The interface 886 illustrated in FIG. 8 can be accessed by a user to create or modify a template, for instance. As shown in FIG. 8, a plurality of selectable object types is presented via the interface 886.

The plurality of selectable object types illustrated in FIG. 8 includes sites, spaces, assets, asset groups, points, teams, work orders, organizations, and components. It is noted that these selectable object types are not to be taken in a limiting sense; embodiments herein are not limited to particular object types. In some embodiments, a user can select one of the plurality of object types via the interface 886 to begin a process of modifying (e.g., creating, updating, deleting etc.) a template associated with the selected object type. For example, selection of the “Assets” display element via the interface 886 can, in some embodiments, cause display of the interface 264 (previously described in connection with FIG. 2).

In accordance with embodiments herein, selection of one of the plurality of display elements via the interface 886 serves as context for a request. Returning to FIG. 7, such a selection can function as a request made by the client 783 for object data from the database 797 with the selected object type serving as context. Stated differently, the selected object type can determine which of the business logic plugins are selected for execution in order to respond to the request. A selection of “assets” for example in the interface 886 can cause the asset specific business logic plugin 787 to be executed.

Subsequent interactions with the interfaces described in connection with FIGS. 2-5 can each carry with them the context object type. For example, interactions of a user customizing aspects of a pump template will be of the “asset” type and can each cause the asset specific business logic plugin to be executed.

On the front end, a user may interact with a single application, as previously described, rather than with different applications for different object types. The application can dynamically render user interfaces (e.g., interfaces like those illustrated in FIGS. 2-5) based upon the object type selected in the interface 886. In some embodiments, for instance, a subset of the features provided by the application may be available to a user that has selected a particular object type while a different subset may be available to a user that has selected a different object type. In some embodiments, one or more sections of the application may be hidden (or shown) based on the selected object type. In some embodiments, different UI permission strings for authorization may be employed for each object type. Dynamic rendering can extend beyond object-dependent rendering. In some embodiments, for instance, one or more functionalities may be available to one user and not to another because the two users have different permissions. This configuration-driven approach provides flexibility to control the behavior of the user interface across different object types without needing separate frontend applications (such as those in previous approaches). It allows the centralization of code while still providing customized user experiences based on object types and user permissions.

Authorization and validation (e.g., input validation) can be performed by an authorization functionality 795 and a validation functionality 793, respectively. The authorization functionality 795 and the validation functionality 793 can be nonspecific to object type. In some embodiments, the business logic plugins (or a different plugin) can include validation functionalities that are specific to one or more object types. That is, some aspects of validation may be performed irrespective of object type and some aspects of validation may correspond to the selected object type. For example, relationships associated with an “asset” model can include relationships between constituent component models of the asset model. Validations for these types of relationships may not apply when the object type is a site, for instance. In another example, the object type “sites” may include validations associated with location coordinates that may not be utilized in an “asset” model.

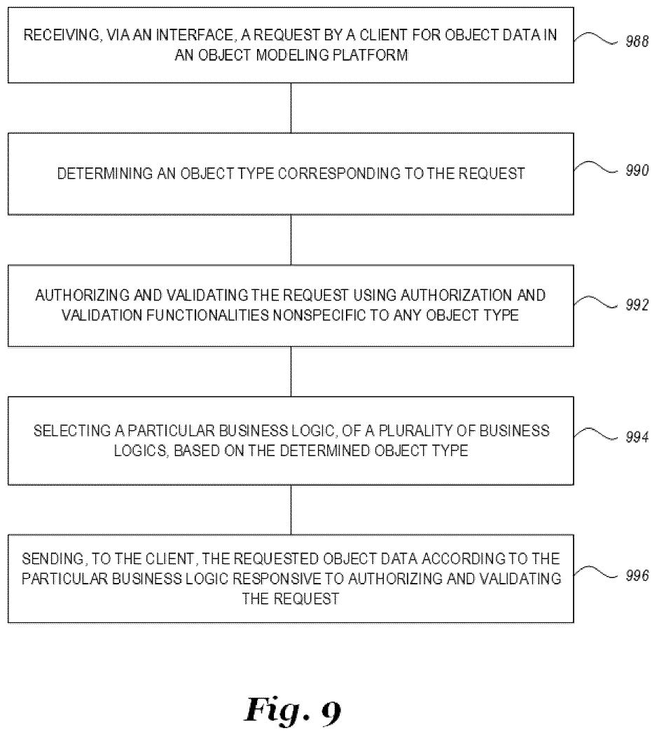

FIG. 9 illustrates an example of a method for extensible object modeling using object type as context, in accordance with one or more embodiments. The method can be performed by, for example, a computing device such as that described below connection with FIG. 10, for instance.

At 988, the method includes receiving, via an interface, a request by a client (e.g., client 783 previously described in connection with FIG. 7) for object data in an object modeling platform. The request can be received responsive to a user selection of a display element corresponding to a particular object type, as previously described herein. For instance, the request can be received responsive to a user interaction with the interface associated with modifying an object instance or an object instance template. Further, the request can be a request to create the object data, a request to read the object data, a request to update the object data, or a request to delete the object data, as previously described herein. The interface can be provided via a single application configured to allow user modification of object templates for each of a plurality of object types.

At 990, the method includes determining an object type corresponding to the request. The object type can be determined based on the context of the request, as previously described herein.

At 992, the method includes authorizing and validating the request using authorization and validation functionalities nonspecific to any object type (e.g., authorization functionality 795 and validation functionality 793, respectively, previously described in connection with FIG. 7). As previously discussed, the authorization and validation functionalities can be common across different object types. As a result, the authorization and validation functionalities can be less duplicative than in previous approaches. Authorizing the request can include determining whether the user is allowed access to the object data based on the role of the user.

At 994 the method includes selecting a particular business logic, of a plurality of business logics (e.g., logic plugins 787, 789, and 791 previously described in connection with FIG. 7), based on the determined object type. Each business logic (e.g., business logic plugin) can be associated with a different object type, such as, for instance, a space, an asset, and a component, and/or the other object types displayed in interface 886 previously described connection with FIG. 8, and the quantity of the plurality of business objects can correspond to the quantity of the display elements in interface 886. A business logic corresponding to “site” can be selected based on the object type being determined to be “site,” for instance.

At 996 the method includes sending, to the client, the requested object data according to the particular business logic responsive to authorizing and validating the request. For instance, the object data may be created, read, updated, or deleted according to the particular business logic responsive to authorization and validation of the request.

In some examples, the request may be validated using an additional validation functionality that is specific to the determined object type. For instance, the additional validation functionality can be a plugin associated with the determined object type, and/or can be executed by the particular business logic.

In some examples, after the particular business logic (e.g., the display element in interface 886) is selected, a subsequent request to create, read, update, or delete an object template of the determined object type can be received. The subsequent request can be authorized and validated using the authorization and validation functionalities, a particular business logic can be selected based on the determined object type, and the object may be created, read, updated, or deleted according to the particular business logic responsive to authorization and validation of the request.

In some examples, an additional request(s) by the client for additional object data in the object modeling platform can be received. In such an example, the method (e.g., blocks 990, 992, 994, and 996) can be performed again in an analogous manner for the additional request(s).

FIG. 10 is an example of a computing device 1001 for extensible object modeling using object type as context, in accordance with one or more embodiments. As illustrated in FIG. 10, the computing device 1001 can include a memory 1003, a processor 1005, and a user interface 1007 for extensible object modeling using object type as context, in accordance with the present disclosure.

The memory 1003 can be any type of storage medium that can be accessed by the processor 1005 to perform various examples of the present disclosure. For example, the memory 1003 can be a non-transitory computer readable medium having computer readable instructions (e.g., executable instructions/computer program instructions) stored thereon that are executable by the processor 1005 for extensible object modeling using object type as context in accordance with the present disclosure.

The memory 1003 can be volatile or nonvolatile memory. The memory 1003 can also be removable (e.g., portable) memory, or non-removable (e.g., internal) memory. For example, the memory 1003 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 1003 is illustrated as being located within computing device 1001, embodiments of the present disclosure are not so limited. For example, memory 1003 can also be located internal to another computing resource (e.g., enabling computer readable instructions to be downloaded over the Internet or another wired or wireless connection).

The processor 1005 may be a central processing unit (CPU), a semiconductor-based microprocessor, and/or other hardware devices suitable for retrieval and execution of machine-readable instructions stored in the memory 1003.

As shown in FIG. 10, computing device 1001 can include a user interface 1007. A user of computing device 1001 can interact with computing device 1001 via user interface 1007. For example, the user interface 1007 can provide (e.g., display and/or present) information to the user of computing device 1001, and/or receive information from (e.g., input by) the user of computing device 1001. For instance, in some embodiments, user interface 1007 can include a graphical user interface (GUI) that can provide and/or receive information to and/or from the user of computing device 1001. The GUI can be, for instance, a touchscreen (e.g., the GUI can include touch-screen capabilities). As an additional example, user interface 1007 (e.g., the GUI) can include a keyboard and/or mouse. However, embodiments of the present disclosure are not limited to a particular type of user interface.

As an example, user interface 1007 can provide (e.g., display) the screenshots previously described in connection with FIGS. 2, 3, 4, 5, and 8 to a user of computing device 1001. For instance, user interface 1007 can provide (e.g., display) an interface for customizing an object template in an object modeling platform, as previously described herein. Further, user interface 1007 can receive selections of causes, manners, etc., as previously described herein.

The user interface 1007 can be localized to any language. For example, the user interface 1007 can display information in any language, such as English, Spanish, German, French, Mandarin, Arabic, Japanese, Hindi, etc.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, via an interface, a request by a client for object data in an object modeling platform;
determining an object type corresponding to the request;
authorizing and validating the request using authorization and validation functionalities nonspecific to any object type;
selecting a particular business logic, of a plurality of business logics, based on the determined object type; and
sending, to the client, the requested object data according to the particular business logic responsive to authorizing and validating the request.

2. The method of claim 1, wherein the method includes determining the object type based on a context of the request.

3. The method of claim 1, wherein the method includes receiving the request responsive to a user interaction with the interface associated with modifying an object instance.

4. The method of claim 1, wherein the method includes receiving the request responsive to a user interaction with the interface associated with modifying an object instance template.

5. The method of claim 1, wherein the request for object data is a request to read the object data.

6. The method of claim 1, wherein the request for object data is a request to delete the object data.

7. The method of claim 1, wherein the method includes providing a plurality of business-logic plugins, each associated with a different object type.

8. The method of claim 7, wherein the different object types include:
a space;
an asset; and
a component.

9. The method of claim 1, wherein the method includes providing the interface via an application configured to allow user modification of object templates for each of a plurality of object types.

10. A non-transitory machine-readable medium having instructions stored thereon which, when executed by a processor, cause the processor to:
receive, via an interface, a request by a client to create, read, update, or delete object data in an object modeling platform;
determine an object type corresponding to the request;
authorize and validate the request using authorization and validation functionalities nonspecific to any object type;
select a particular business logic, of a plurality of business logics, based on the determined object type; and
create, read, update, or delete the object data according to the particular business logic responsive to authorization and validation of the request.

11. The medium of claim 10, including instructions to receive the request responsive to a selection of a display element from among a plurality of display elements provided by the object modeling platform, wherein each of the plurality of display elements corresponds to a different object type.

12. The medium of claim 11, including instructions to provide a subsequent interface responsive to the selection of the display element, wherein the subsequent interface is configured based on the object type.

13. The medium of claim 12, including instructions to:
enable a subset of a plurality of features of the object modeling platform corresponding to the object type; and
enable a subset of functionalities of the object modeling platform corresponding to the object type.

14. The medium of claim 13, including instructions to:
authorize and validate the subsequent request using the authorization and validation functionalities;
select the particular business logic, of the plurality of business logics, based on the determined object type; and
create, read, update, or delete the object template according to the particular business logic responsive to authorization and validation of the subsequent request.

15. The medium of claim 10, wherein the plurality of business logics include respective business logics associated with each of: site, space, asset, asset group, point, team, work order, organization, and component.

16. A computing device, comprising:
a user interface;
a processing resource; and
a memory resource storing non-transitory machine-readable instructions to cause the processing resource to:
receive, via the interface, a request by a client for object data in an object modeling platform;
determine an object type corresponding to the request;
authorize the request using an authorization functionality nonspecific to any object type;
validate the request using a first validation functionality nonspecific to any object type and a second validation functionality specific to the determined object type;
select a particular business logic, of a plurality of business logics, based on the determined object type; and
send, to the client, the requested object data according to the particular business logic responsive to authorizing and validating the request.

17. The computing device of claim 16, wherein the second validation functionality is a plugin associated with the determined object type.

18. The computing device of claim 16, wherein the second validation functionality is executed by the particular business logic.

19. The computing device of claim 16, wherein the instructions to authorize the request include instructions to determine whether a user is allowed access to the object data based on a role of the user.

20. The computing device of claim 16, including instructions to:
receive, via the interface, an additional request by the client for additional object data in the object modeling platform;
determine an additional object type corresponding to the additional request;
authorize the additional request using the authorization functionality nonspecific to any object type;
validate the additional request using the first validation functionality nonspecific to any object type and a third validation functionality specific to the additional determined object type;
select an additional particular business logic, of the plurality of business logics, based on the additional determined object type; and
send, to the client, the additional requested object data according to the additional particular business logic responsive to authorizing and validating the additional request.
